(19) United States
(12) Patent Application Publication
(10) Pub. No.: US 2018/0039065 A1
(43) Pub. Date: Feb. 8, 2018

(54) LINEARLY DISPOSED EYEPIECE VIDEO DISPLAY

(71) Applicant: TELEPATHY JAPAN INC., Tokyo (JP)

(72) Inventor: Junichi IWAI, Tokyo (JP)

(21) Appl. No.: 15/551,273

(22) PCT Filed: Sep. 28, 2015
(86) PCT No.: PCT/JP2015/077270

§ 371 Date: Aug. 15, 2017

(30) Foreign Application Priority Data
Feb. 16, 2015 (JP) 2015-028072

(51) Int. Cl. G02B 25/00; G02B 27/01; G02B 27/28

(52) U.S. Cl. CPC G02B 25/001; G02B 27/283; G02B 27/0172; G02B 27/0176; G02B 2027/015; G02B 2027/0145

(57) ABSTRACT

Provided are a compact eyepiece video display, and a head mounted display equipped with an eyepiece video display. In a display optical system (1), a polarization separation element (10) reflects first polarization light component while transmitting second polarization light component. A light source (20) emits light toward the polarization separation element (10). A reflection part (30) converts the first polarization light component included in the light output from the light source (20) and reflected from the polarization separation element (10) into the second polarization light component while reflecting the light output so that the light output enters the polarization separation element (10). A reflection type video display element (40) reflects the light reflected from the reflection part (30) transmitted through the polarization separation element (10) while converting the reflection light into video light including the first polarization light component to thus cause the video light to enter the polarization separation element (10). Thereby, the first polarization light component included in the video light reflected from the polarization separation element (10) is incident on an eyepiece optical system (2).

### TECHNICAL FIELD

The present invention relates to an eyepiece video display mounted on a head mounted display (HMD) or the like. To be specific, the video display according to the present invention is an optical device that is installed in front of an observer's eye and causes the observer to visually recognize an image by guiding image light generated using a reflective liquid crystal display (reflective LCD) to an observer's pupil.

### BACKGROUND ART

In recent years, a demand for a wearable device, which can be used in the state of being attached to a body of a user, for example, an HMD used in the state of being mounted on a head, has increased. In addition, for example, video displays such as computers, various sensor devices, and LCDs have been also downsized to such an extent of being mountable to wearable devices, and development of wearable devices mounting such devices has rapidly progressed. Such an HMD generally includes a display optical system that emits image light and an eyepiece optical system that guides the image light emitted from the display optical system to the observer's pupil.

Meanwhile, it is known that a transmissive type and a reflective type are used as a liquid crystal display that displays an image, in an image display optical system. The transmissive liquid crystal display is configured such that a light source is provided on a back side of a liquid crystal element, and image light is generated as output light from the light source is transmitted through the liquid crystal element. On the other hand, the reflective liquid crystal display is configured such that a reflection plate is provided on a back side of a liquid crystal element, light is made incident from a front side of the liquid crystal element, and image light is generated as the light transmitted through the liquid crystal element is reflected by the reflection plate. The transmissive liquid crystal display has a demerit that accuracy of an image deteriorates when external light is incident, and is considered to be unsuitable to be mounted to a video display used outdoors such as the HMD. For this reason, the reflective type has recently attracted attention as the liquid crystal display amounted to the HMD (Patent Literature 1 and the like).

### CITATION LIST

### Patent Literature

Patent Literature 1: JP 2012-168239 A

### SUMMARY OF INVENTION

### Technical Problem

FIG. 5 is a schematic diagram illustrating a configuration of a conventional HMD using a reflective liquid crystal display as disclosed in Patent Literature 1, for example. As illustrated in FIG. 5, the conventional HMD is designed such that a main optical axis direction of light output from a light source and a main optical axis direction of light incident on a prism forming an eyepiece optical system are orthogonal to each other. More specifically, the conventional HMD includes a polarizing beam splitter (PBS), and light including a P-polarized component and an S-polarized component is made incident on the PBS from the light source. Output light from the light source is collected by a condenser lens, and the S-polarized component transmitted through a polarizing plate is reflected by a polarization separation surface of the PBS to progress in an orthogonal direction, and is guided to a reflective liquid crystal (for example, liquid crystal on silicon (LCOS) (registered trademark)). The reflective liquid crystal is controlled by a control circuit (not illustrated), modulates light of the S-polarized component incident from the PBS to generate predetermined image light, and reflects the image light toward the PBS. This image light includes the P-polarized component and the S-polarized component. Thus, when the image light is introduced into the PBS the light of the S-polarized component among the image light is reflected by the PBS, and light of the P-polarized component is transmitted through the PBS. The light of the P-polarized component that has been transmitted through the PBS is guided to the prism forming the eyepiece optical system arranged opposite to the reflective liquid crystal. Accordingly, the image light emitted from a display optical system including the PBS is configured to be guided to an observer's pupil by the eyepiece optical system including the prism.

Meanwhile, since the HMD is worn on the head of the observer and the eyepiece optical system is positioned in front of the observer's eye, it is necessary to make a configuration of an eyepiece video display slim as a whole. In the eyepiece video display using the reflective liquid crystal, however, the main optical axis direction of the light output from the light source forming the display optical system and the main optical axis direction of the light incident on the prism forming the eyepiece optical system are orthogonal to each other, as illustrated in FIG. 5. In such a configuration, it is necessary to arrange the light source and the prism in an orthogonal manner, and thus, there is a problem that it is difficult to make the configuration of the eyepiece video display slim while decreasing a degree of freedom in design of the HMD.

Thus, at present, there is a demand for a technique that is capable of configuring the eyepiece video display using a reflective image element (reflective liquid crystal or the like) to be compact and capable of enhancing the degree of freedom in design thereof.

### Solution to Problem

The inventor of the present invention has obtained findings that it is possible to arrange a light source and an eyepiece optical system (prism) on a straight line by reflecting output light from the light source by a polarization separation element to be guided to a reflection section configured of a mirror or the like, introducing the light reflected by the reflection section into a reflective image element to generate image light, and reflecting the image light again by the polarization separation element, as a result of intensive studies on a solution to the problem of the related art. Further, the present inventor has conceived that it is possible to configure an eyepiece video display to be compact using the reflective image element by arranging the light source and the eyepiece optical system on a straight line, and completed the present invention. To be specific, the present invention has the following configurations.

A first aspect of the present invention relates to an eyepiece video display mounted on an HMD or the like.

The eyepiece video display of the present invention includes a display optical system 1 that emits image light and an eyepiece optical system 2 that guides the image light emitted from the display optical system 1 to an observer's pupil.

Here, the display optical system 1 includes a polarization separation element 10, a light source 20, a reflection section 30, and a reflective image element 40.

The polarization separation element 10 reflects first polarized component light as linearly polarized light and transmits second polarized component light as linearly polarized light having a different polarization plane from the first polarized component light.

The light source 20 outputs light to the polarization separation element 10.

The reflection section 30 converts the first polarized component light included in output light from the light source 20 that has been reflected by the polarization separation element 10 into the second polarized component light. In addition, the reflection section 30 reflects this output light to be incident on the polarization separation element 10.

The reflective image element 40 reflects reflection light from the reflection section 30 that has been transmitted through the polarization separation element 10. In addition, at the same time, the reflective image element 40 converts the reflection light into image light including at least the first polarized component light, and causes this image light to be incident on the polarization separation element 10.

Accordingly, the eyepiece video display of the present invention is configured such that the first polarized component light included in the image light reflected by the polarization separation element 10 is incident on the eyepiece optical system 2.

With the above-described configuration, it is possible to align the eyepiece optical system 2, the polarization separation element 10, and the light source 20 on a straight line in the eyepiece video display of the present invention. That is, the eyepiece optical system 2 is positioned in a main optical axis direction of the output light from the light source 20. Therefore, it is possible to realize a slim configuration in which the eyepiece optical system 2, the polarization separation element 10, and the light source 20 are aligned on a straight line, and to enhance a degree of freedom in design of the eyepiece video display and the HMD including the same according to the present invention.

In the present invention, it is preferable that the eyepiece optical system 2 further include one or a plurality of polarizing plates 21. The polarizing plate 21 may be a first polarizing plate 21a arranged between the light source 20 and the polarization separation element 10 or may be a second polarizing plate 21b arranged between the polarization separation element 10 and the eyepiece optical system 2. In addition, the eyepiece optical system 2 may include both the first polarizing plate 21a and the second polarizing plate 21b. Further, each of the polarizing plates 21 has a function of transmitting the first polarized component light included in the output light from the light source 20 and blocking the second polarized component light.

When the polarizing plate 21 is arranged between the light source 20 and the polarization separation element 10 as in the above-described configuration, the unnecessary second polarized component light that is not reflected by the polarization separation element 10 is removed, and thus, it is possible to prevent unnecessary light from being incident on the eyepiece optical system 2.

In the present invention, it is preferable that the reflection section 30 include a quarter wave plate 31 and a mirror 32.

The quarter wave plate 31 converts the first polarized component light included in the output light from the light source 20, which has been reflected by the polarization separation element 10, into circularly polarized light and causes the circularly polarized light to be incident on the mirror 32.

The mirror 32 reflects the circularly polarized light that has passed through the quarter wave plate 31.

Thereafter, the quarter wave plate 31 converts the circularly polarized light reflected by the mirror 32 into the second polarized component light and causes the second polarized component light to be incident on the polarization separation element 10.

When the quarter wave plate 31 and the mirror 32 are used as in the above-described configuration, it is possible to efficiently convert the first polarized component light reflected by the polarization separation element 10 into the second polarized component light that can be transmitted through the polarization separation element 10. Thus, it is possible to cause the clear image light to be incident on the eyepiece optical system 2.

In the present invention, it is preferable that the mirror 32 be a retroreflective mirror.

The retroreflective mirror means a mirror that is capable of reflecting (retroreflection) incident light in an incident direction thereof. The retroreflective mirror is capable of reflecting the incident light directly in the incident direction, which is different from reflection using a typical mirror in which the incident angle and a reflection angle are equal. When the typical mirror is adopted in the configuration of the eyepiece video display according to the present invention, there are a problem that an optical path length in the device becomes long and is hardly downsized and a problem that it is necessary to increase the intensity of the light output from the light source 20 so that a burden is imposed on an illumination system. In contrast, when the retroreflective mirror is adopted as the mirror provided in the reflection section 30 as in the above-described configuration, it is possible to shorten the optical path length in the device as a whole. Accordingly, the burden on the illumination system can be reduced, and thus, it is possible to extend service life of a battery or the like to drive the eyepiece video display.

A second aspect of the present invention relates to a head mounted display (HMD) including the eyepiece video display according to the first aspect. Except for the configuration of the eyepiece video display described above, known configurations can be appropriately adopted regarding the other configurations of the head mounted display.

### Advantageous Effects of Invention

According to the present invention, it is possible to configure the eyepiece video display using the reflective image element to be compact and to enhance the degree of freedom in design thereof.

### BRIEF DESCRIPTION OF DRAWINGS

FIG. 1 is a block diagram illustrating an overview of a configuration of an eyepiece video display according to the present invention.

FIG. 2 is a block diagram illustrating a polarization state and a progressing direction of light in the eyepiece video display according to the present invention.

FIG. 3 is a view obtained by modeling an optical path in the eyepiece video display according to the present invention, and illustrates an example using a typical mirror.

FIG. 4 is a view obtained by modeling an optical path in the eyepiece video display according to the present invention, and illustrates an example using a retroreflective mirror.

FIG. 5 is a block diagram illustrating an overview of a conventional eyepiece video display mounting a reflective liquid crystal.

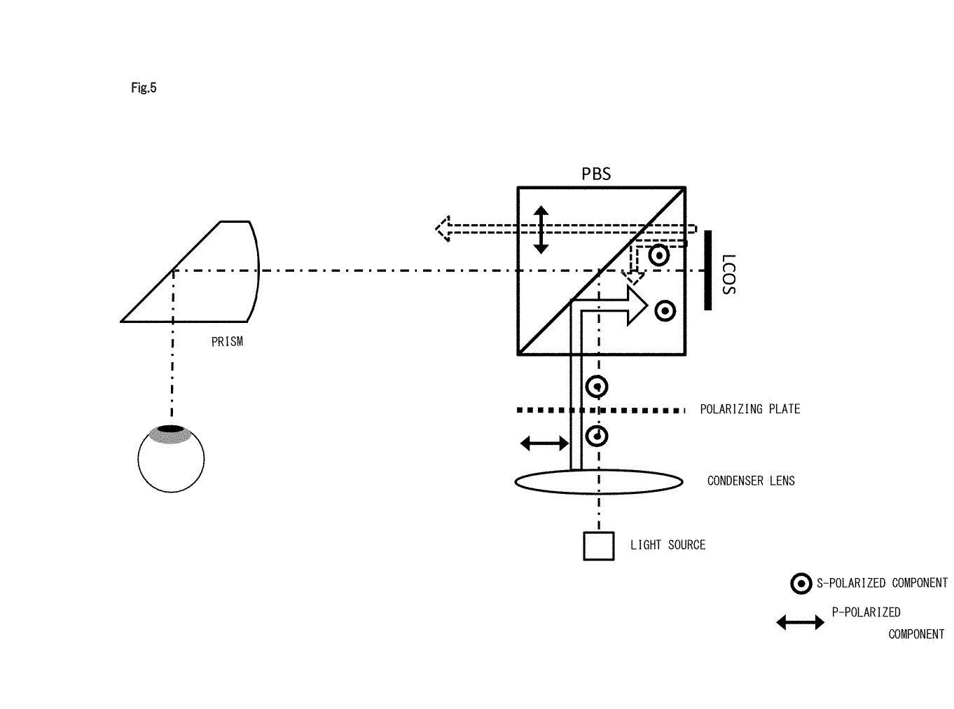

### DESCRIPTION OF EMBODIMENTS

Hereinafter, an embodiment of the present invention will be described with reference to the drawings. The present invention is not limited to the embodiments described below, but includes changes thereto made appropriately by those skilled in the art to the extent obvious.

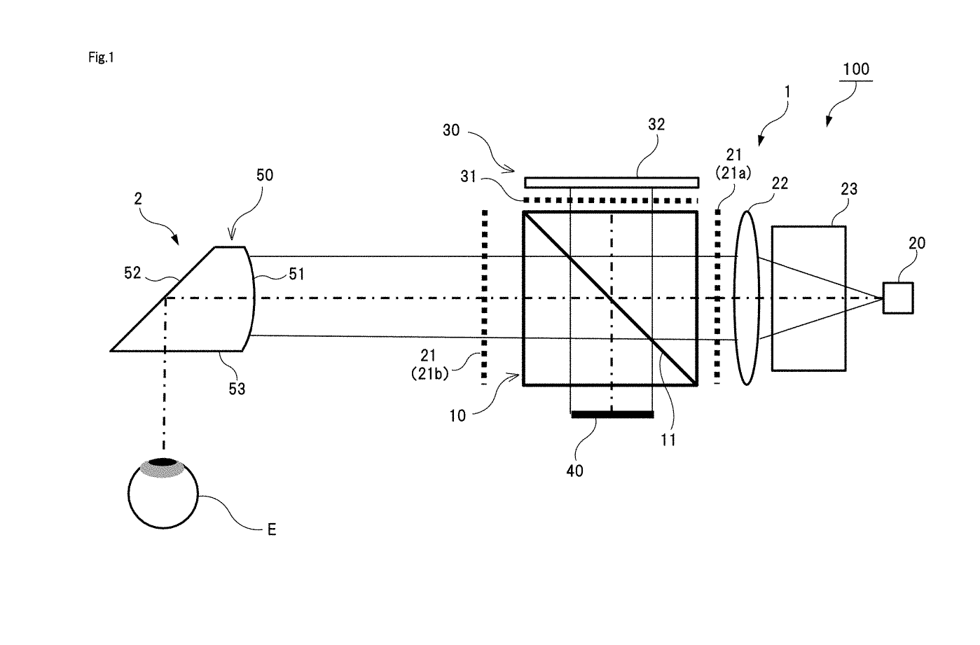

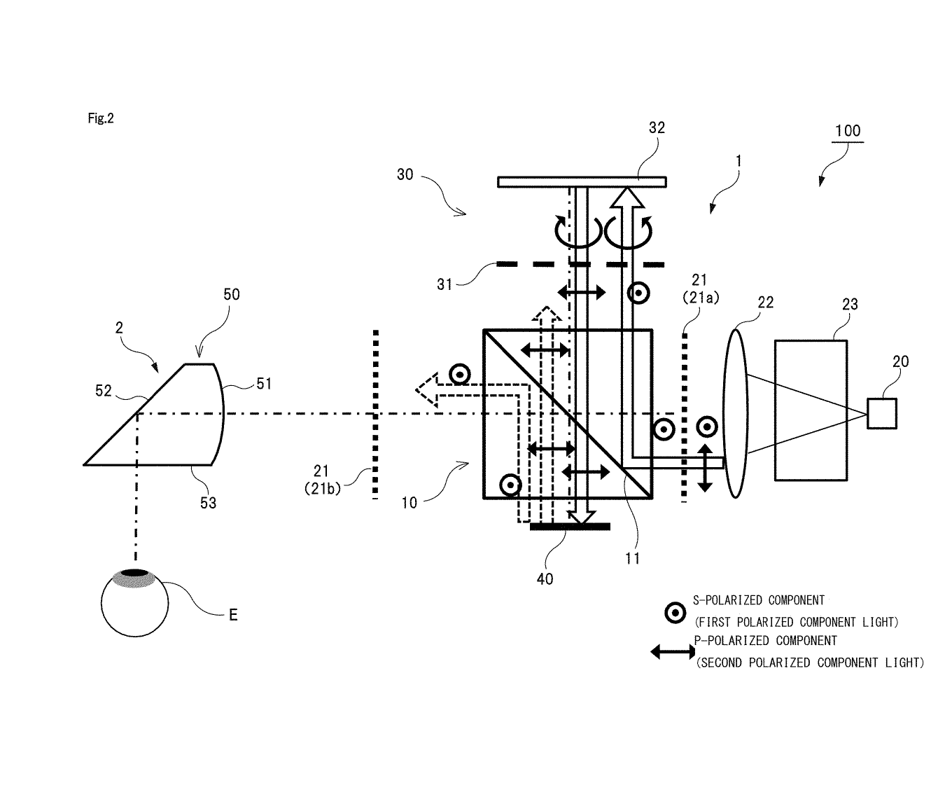

FIG. 1 schematically illustrates a configuration of an eyepiece video display 100 according to an embodiment of the present invention. In addition, FIG. 2 schematically illustrates a polarization state of light and a progressing direction thereof in the eyepiece video display 100 according to the embodiment of the present invention. As illustrated in FIGS. 1 and 2, the eyepiece video display 100 includes a display optical system 1 and an eyepiece optical system 2. The display optical system 1 includes a light source and an image element such as a liquid crystal display, and generates desired image light to be emitted toward the eyepiece optical system 2. In addition, the eyepiece optical system 2 includes an optical element such as a prism and guides the image light emitted from the display optical system 1 to a pupil E of an observer. Thus, the eyepiece optical system 2 is arranged in the vicinity of the pupil E of the observer. Accordingly, the observer can visually recognize a virtual image of an image displayed by the display optical system 1.

As illustrated in FIG. 1, the display optical system 1 includes a polarization separation element 10, a light source 20, a polarizing plate 21 (a first polarizing plate 21a and/or a second polarizing plate 21b), a condenser lens 22, a uniformizing element 23, a reflection section 30, and a reflective image element 40.

The polarization separation element 10 is an optical element that reflects first polarized component light as linearly polarized light and transmits second polarized component light as linearly polarized light having a different polarization plane from the first polarized component light. In the example illustrated in FIG. 1, a polarizing beam splitter (PBS) is used as the polarization separation element 10. However, a known polarizing element for light separation, such as a wire grid polarizer, can also be used as the polarization separation element 10. The polarization separation element 10 (PBS) has a structure in which two right angle prisms are bonded to each other, and a bonding face between the right angle prisms is coated with a dielectric multilayer film, a metal thin film, or the like. Therefore, this bonding face functions as a polarization separation surface 11 that transmits or separates light according to its polarization state. In addition, in the example illustrated in FIG. 1, the polarization separation surface 11 reflects S-polarized component light at a substantially right angle when the S-polarized component light is incident on this surface, and transmits P-polarized component light when the P-polarized component light is incident thereon as illustrated in FIG. 2. However, it is also possible to use a material that reflects the P-polarized component light and transmits the S-polarized component light as the polarization separation surface 11. Hereinafter, a description will be given by exemplifying a case where the S-polarized component light is a light component (first polarized component light) that is reflected by the polarization separation surface 11, and the P-polarized component light is a light component (second polarized component light) that is transmitted through the polarization separation surface 11.

The light source 20 outputs light to the polarization separation element 10. The light source 20 is connected to a control circuit and a power supply (not illustrated), and outputs light according to control of the control circuit. A known light emitting diode (LED) or the like can be used as the light source 20. The output light from the light source 20 includes at least the S-polarized component light (first polarized component light), and may further include the P-polarized component light (second polarized component light).

As illustrated in FIG. 1, the first polarizing plate 21a, the condenser lens 22, and the uniformizing element 23 are arranged between the polarization separation element 10 and the light source 20. The output light from the light source 20 is uniformized in illumination or the like by the uniformizing element 23, and then, guided to the polarization separation element 10 by the condenser lens 22 such as a telecentric lens. In addition, the first polarizing plate 21a is arranged between the condenser lens 22 and the polarization separation element 10. The first polarizing plate 21a transmits the S-polarized component light included in the output light from the light source 20 and blocks the P-polarized component light. Accordingly, only the S-polarized component light among the output light from the light source 20 is introduced into the polarization separation element 10. In addition, the second polarizing plate 21b can also be provided between the polarization separation element 10 and the eyepiece optical system 2 as illustrated in FIG. 1. The second polarizing plate 21b transmits the S-polarized component light and blocks the P-polarized component light, which is similar to the first polarizing plate 21a. It is possible to prevent unnecessary light from being incident to the display optical system 1 by providing both or any one of the first polarizing plate 21a and the second polarizing plate 21b in this manner. Known optical elements can be appropriately used as the polarizing plate 21 (the first polarizing plate 21a and/or the second polarizing plate 21b), the condenser lens 22, and the uniformizing element 23.

The reflection section 30 has a function of converting the polarization state of the incident light and a function of reflecting the incident light. The reflection section 30 is arranged at a position on which the output light (S-polarized component light) from the light source 20 that has been reflected by the polarization separation surface 11 of the polarization separation element 10 is incident. As illustrated in FIG. 1, the reflection section 30 is configured of a quarter wave plate 31 and a mirror 32 in the present embodiment. The quarter wave plate 31 converts the polarization state of the incident light from linearly polarized light into circularly polarized light or from circularly polarized light into linearly polarized light. The quarter wave plate 31 is arranged between the polarization separation element 10 and the mirror 32. Thus, the quarter wave plate 31 converts the polarization state of the S-polarized component light reflected from the polarization separation element 10 from linearly polarized light into circularly polarized light and converts the circularly polarized light reflected from the mirror 32 into linearly polarized light again. In addition, the quarter wave plate 31 shifts a phase of light to be transmitted again by 90 degrees with respect to a phase of the incident light and outputs the phase-shifted light at the time of re-converting the circularly polarized light reflected from the mirror 32 into the linearly polarized light. That is, when the light incident on the quarter wave plate 31 is the S-polarized component light, the light reflected by the mirror 32 and re-transmitted through the quarter wave plate 31 becomes the P-polarized component light. In this manner, the reflection section 30 configured of the quarter wave plate 31 and the mirror 32 has the function of converting the S-polarized component light (first polarized component light) into the P-polarized component light (second polarized component light). In addition, it is preferable to adopt a retroreflective mirror, which is capable of reflecting (retroreflection) incident light in an incident direction thereof, as the mirror 32. However, it is also possible to adopt a typical mirror in which an incident angle and a reflection angle are equal as the mirror 32. A merit of adopting the retroreflective mirror will be described later in detail.

The reflective image element 40 is an optical member that reflects incident light and performs predetermined modulation to this incident light (reflected light) to generate image light to enable the observer to visually recognize the light. For example, a known reflective liquid crystal display can be used as the reflective image element 40. The reflective image element 40 is arranged at a position opposing the reflection section 30 (particularly, the mirror 32) with the polarization separation element 10 interposed therebetween. Thus, the light (P-polarized component light), which has been transmitted through the polarization separation element 10 among the reflection light reflected by the reflection section 30, is incident on the reflective image element 40. The reflective image element 40 modulates the P-polarized component light to generate the image light including at least the S-polarized component light and reflects this image light toward the polarization separation element 10. Incidentally, it is enough if the reflective image element 40 includes at least the S-polarized component light (first polarized component light), and the P-polarized component light (second polarized component light) may be included in addition to the S-polarized component light.

The image light generated by the reflective image element 40 is incident on the polarization separation element 10, and the S-polarized component light (first polarized component light) included in the image light is reflected at a substantially right angle at the polarization separation surface 11, and the P-polarized component light (second polarized component light) is transmitted. The image light of the S-polarized component light reflected by the polarization separation element 10 progresses straight in the air and is incident on the eyepiece optical system 2.

The eyepiece optical system 2 includes a prism 50. The prism 50 is a light guide member (optical crystal) that guides the image light internally. The prism 50 has, for example, a shape including an entrance surface 51, a reflective surface 52, and an exit surface 53 of the image light. Incidentally, the prism 50 may be configured using a single prism or may be configured by combining a plurality of prisms. The entrance surface 51 of the prism 50 is provided in a direction perpendicularly intersecting an optical axis of the image light. In addition, the exit surface 53 is provided so as to oppose the observer's pupil E. The reflective surface 52 has, for example, a rectangular shape (oblong shape), and functions as a unit to fold the optical path of the image light at a right angle. Specifically, the reflective surface 52 reflects the image light incident on the inside of the prism via the entrance surface 51 at a substantially right angle to be emitted from the exit surface 53. Accordingly, the image light guided inside the prism 50 of the eyepiece optical system 2 is incident on the observer's pupil E.

Next, an operation of the eyepiece video display 100 according to the present invention will be described with reference to FIG. 2.

As illustrated in FIG. 2, the light output from the light source 20 is incident on the first polarizing plate 21a via the uniformizing element 23 and the condenser lens 22. The first polarizing plate 21a transmits only the S-polarized component light (first polarized component light) among the output light from the light source 20 and blocks the P-polarized component light (second polarized component light). The S-polarized component light transmitted through the first polarizing plate 21a is incident on the polarization separation element 10, reflected at a substantially right angle at the polarization separation surface 11, and guided to the reflection section 30. In the reflection section 30, the S-polarized component light is converted into the circularly polarized light at the time of passing through the quarter wave plate 31, is reflected by the mirror 32 in the same direction as the incident direction thereof, and passes through the quarter wave plate 31 again. At this time, the circularly polarized light reflected by the mirror 32 is converted into the P-polarized component light. The P-polarized component light emitted from the reflection section 30 in this manner passes through the polarization separation element 10 and is incident on the reflective image element 40. The reflective image element 40 modulates the P-polarized component light to generate the image light including at least the S-polarized component light, and further, reflects this image light toward the polarization separation element 10. The image light including the S-polarized component light is reflected at a substantially right angle by the polarization separation surface 11 of the polarization separation element 10, propagates in the air, and is guided to the prism 50 forming the eyepiece optical system 2. Incidentally, the second polarizing plate 21b may be provided between the polarization separation element 10 and the prism 50 instead of the first polarizing plate 21a or together with the first polarizing plate 21a. The P-polarized component light transmitted through the polarization separation element 10 may be blocked by the second polarizing plate 21b. Further, the prism 50 guides the incident image light to the observer's pupil E. Accordingly, it is possible to generate the image light by modulating the light output from the light source 20 using the reflective image element 40 and to allow the observer to visually recognize this image light.

As illustrated in FIGS. 1 and 2, it is possible to arrange the light source 20, the polarization separation element 10, and the prism 50 on a straight line in the eyepiece video display 100 of the present invention. That is, the polarization separation element 10 and the prism 50 are positioned in a main optical axis direction of the light output from the light source 20. Therefore, it is possible to realize a slim configuration in which the light source 20, the polarization separation element 10, and the prism 50 are arranged on a straight line, and to enhance a degree of freedom in design of the eyepiece video display 100 and the HMD including the same according to the present invention.

Next, the merit of using the retroreflective mirror as the above-described mirror 32 will be described.

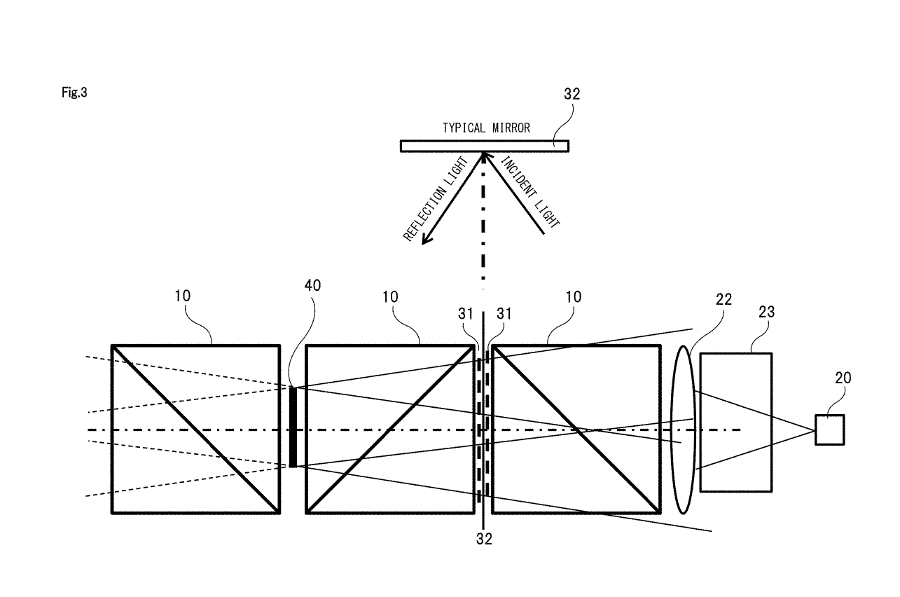

First, FIG. 3 illustrates a view obtained by modeling an optical path in the eyepiece video display 100, and illustrates an example of using the typical mirror. In a typical mirror 32, an incident angle and a reflection angle of light are equal. When a dispersion width of light propagating inside the device around the reflective image element 40 is given as illustrated in FIG. 3 in the case of using the typical mirror 32, the dispersion width of light is widened and light progressing to the outside from the inside of the device also appears. Thus, when the typical mirror 32 is used, the amount of light guided to the eyepiece optical system 2 decreases among the light output from the light source 20, and there is a problem that an image to be visually recognized by the observer becomes dark. Therefore, it is necessary to increase the intensity of the light output from the light source 20 in order to set brightness of the image, visually recognized by the observer, to be a certain value or more, which imposes a burden on the illumination system. In addition, it is necessary to increase an optical path length of light or to increase the number of lenses for collection of light in order to prevent the light inside the device from leaking to the outside. Then, there is a problem that the number of components of the device increases or the configuration of the device is increased in size in the case of using the typical mirror 32.

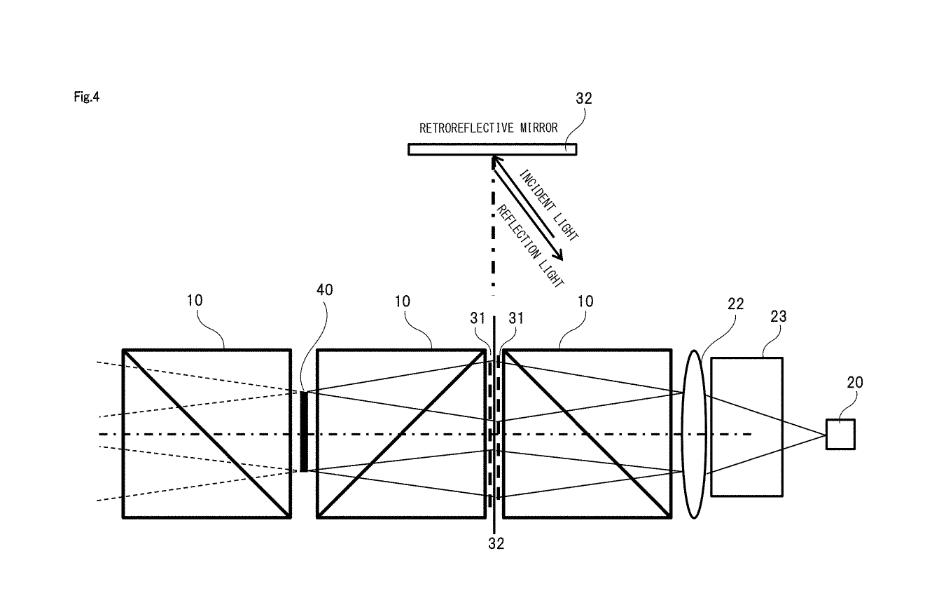

FIG. 4 illustrates a model view when the retroreflective mirror is used as the mirror 32. The retroreflective mirror can reflect (retroreflection) the incident light in the incident direction thereof. As illustrated in FIG. 4, the dispersion width of the light propagating inside the device is narrowed to an extent of being fit inside the device in the case of using the retroreflective mirror 32 as compared to the case of using the typical mirror illustrated in FIG. 3. That is, it is possible to prevent the light from leaking from the inside of the device to the outside by employing the retroreflective mirror 32. Accordingly, it is possible to guide substantially the whole amount of the light output from the light source 20 to the reflective image element 40, and further, it is also possible to guide substantially the whole amount of the image light generated by the reflective image element 40 to the eyepiece optical system 2. Therefore, when the retroreflective mirror 32 is used, it is possible to set the intensity of the light output from the light source 20 to be lower than that in the case of adopting the typical mirror. Accordingly, it is possible to reduce the burden on the illumination system and to save a battery to drive the eyepiece video display. In addition, it is possible to suppress the dispersion of light by employing the retroreflective mirror 32, and thus, it is possible to shorten the optical path length of light. In addition, an optical component such as an unnecessary lens becomes unnecessary, and it is possible to simplify the entire configuration of the device. Therefore, it is possible to realize the inexpensive and compact eyepiece video display 100 by employing the retroreflective mirror 32.

The eyepiece video display 100 of the present invention is preferably used as a video display which is mounted on the HMD. Specifically, the HMD has a structure in which the eyepiece optical system 2 of the eyepiece video display 100 is arranged in front of one eye or both eyes of a user in the state of being worn around the user's head or neck. In addition, various sensors such as a camera, a microphone, a gyro sensor, and an optical sensor can be mounted to the HMD. A known configuration may be appropriately adopted as the configuration of the HMD. For example, it is possible to adopt a configuration of an HMD disclosed in Japanese Patent Application No. 5420793 and Japanese Patent Application No. 5593429.

The embodiment of the present invention has been described as above with reference to drawings in the specifications of the present application in order to express the content of the present invention. However, the present invention is not limited to the embodiment described hereinbefore, and encompasses obvious modifications and improvements made by those skilled in the art based on the matters described in the specifications of the present application.

### INDUSTRIAL APPLICABILITY

The present invention relates to the eyepiece video display mounted to the HMD or the like. Thus, the present invention can be suitably used in a wearable device manufacturing industry.

### REFERENCE SIGNS LIST

1 Display optical system
2 Eyepiece optical system
10 Polarization separation element
11 Polarization separation surface
20 Light source
21 Polarizing plate
22 Condenser lens
23 Uniformizing element
30 Reflection section
31 Quarter wave plate
32 Mirror
40 Reflective image element
50 Prism
51 Entrance surface
52 Reflective surface
53 Exit surface
100 Eyepiece video display

1. An eyepiece video display comprising:
a display optical system (1) that emits image light;
an eyepiece optical system (2) that guides the image light emitted from the display optical system (1) to a pupil of an observer;
wherein the eyepiece video display includes:
a polarization separation element (10) that reflects first polarized component light which is linearly polarized light and transmits second polarized component light which is linearly polarized light having a different polarization plane from the first polarized component light;
a light source (20) that outputs light to the polarization separation element (10);
a reflection section (30) that converts the first polarized component light included in the light output from the light source (20), reflected by the polarization separation element (10), into the second polarized component light, and reflects the output light to be incident on the polarization separation element (10); and
a reflective image element (40) that reflects the light reflected from the reflection section (30), transmitted through the polarization separation element (10), converts the reflected light into the image light including at least the first polarized component light, and causes the converted light to be incident on the polarization separation element (10),
wherein the first polarized component light included in the image light reflected by the polarization separation element (10) is incident on the eyepiece optical system (2).

2. The eyepiece video display according to claim 1,
wherein the display optical system (1), the polarization separation element (10), and the light source (20) are aligned on a straight line.

3. The eyepiece video display according to claim 1,
wherein the eyepiece optical system (2) further includes the polarizing plate (21), which transmits the first polarized component light included in the output light from the light source (20) and blocks the second polarized component light at both portions or any one portion between the light source (20) and the polarization separation element (10) and between the polarization separation element (10) and the eyepiece optical system (2).

4. The eyepiece video display according to claim 1,
wherein the reflection section (30) includes a quarter wave plate (31) and a mirror (32),
the quarter wave plate (31) converts the first polarized component light included in the output light from the light source (20), reflected by the polarization separation element (10), into circularly polarized light, and causes the converted light to be incident on the mirror (32)
the mirror (32) reflects the circularly polarized light passing through the quarter wave plate (31), and
the quarter wave plate (31) converts the circularly polarized light reflected by the mirror (32) into the second polarized component light and causes the converted light to be incident on the polarization separation element (10).

5. The eyepiece video display according to claim 4,
wherein the mirror (32) is a retroreflective mirror.

6. A head mounted display comprising the eyepiece video display according to claim 1.
